(19) United States
(12) Patent Application Publication
(10) Pub. No.: US 2004/0203755 A1
(43) Pub. Date: Oct. 14, 2004

(54) Mobile care framework

(76) Inventors: Jeffrey Brunet, Toronto (CA); Ian Collins, Markham (CA); Stephen Kim, Thornhill (CA); Yousuf Chowdhary, Maple (CA)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/822,092

(22) Filed: Apr. 9, 2004

Related U.S. Application Data
(60) Provisional application No. 60/461,886, filed on Apr. 11, 2003.

(51) Int. Cl. H04Q 7/20

(52) U.S. Cl. 455/432.1

(57) ABSTRACT

A Mobile Care Framework is provided which uses an embedded diagnostic component, a device agent, to forward device profile data and receive update and problem solutions for implementation and execution with the device. Preferably, the data and solutions are communicated with a remotely located customer care application within the Mobile Care Framework using over-the-air communication.

### RELATED APPLICATIONS

This application claims the benefit of U.S. Patent Application No. 60/461,886 filed Apr. 11, 2003.

### FIELD OF THE INVENTION

The invention relates to customer service support systems, and more particularly to customer service support systems for wireless communications devices.

### BACKGROUND OF THE INVENTION

For the first time in the history of telecommunications networks, significant computing power has become available at the subscriber terminal. This change has the ability to reshape the architecture of all mobile telecommunications networks. Traditionally the Operational Support Systems/Business Support Systems (OSS/BSS) were large scale, extremely complex, centralized systems within the MSP's (Mobile Service Provider's) network. With the proliferation of next generation smartphones and wireless PDAs significant intelligence can be pushed out to the subscriber terminal, and thus the ability to greatly simplify mobile customer care has emerged.

The telecommunications industry is on the verge of a revolution in support system technologies. A rare intersection of technological change has become apparent in the mobile industry. Mobile data networks have been deployed around the world. These networks provide fast reliable packet data to subscriber's mobile devices. At the same time, intelligent mobile devices have emerged as capable computing platforms with considerable processing power, onboard storage and memory. This combination of events has provided the opportunity to exponentially improve upon the mobile device support solutions offered by wireless network operators.

With the emergence of smartphones and wireless PDAs and their ability to download and install applications, the wireless industry is poised to see explosive growth in application usage by subscribers. Mobile operator customer care centers are focused on solutions for closed, voice-centric mobile phones. This infrastructure is not suited to efficiently solve intelligent mobile data device and application problems that are bound to arise with the proliferation of next generation “smartphone” devices.

It is clear that mobile data has emerged as a solid technology with proven business models. Mobile customers around the world can subscribe to GPRS and CDMA 1× rate plans that are affordable, provide excellent coverage and ‘always-on’ data connections to the Internet and corporate servers. 3G services offering an even greater level of connectivity and data throughput are also beginning to emerge.

Supporting this new generation of devices provides a new challenge to wireless operators. Making use of current infrastructure attempting to provide timely, efficient support for mobile data devices is a complex and time-consuming undertaking. Too often, the effort required to gather complete, accurate diagnostic information is too high, both for the technical support staff and for the subscribers who must supply the information.

The typical support experience for technology products forces both end users and customer service reps to wade through highly technical Web sites, complex documentation, or long and cryptic ‘question and answer’ sessions to get the information required to solve the end user's problem. Our invention, the Mobile Care Framework streamlines this process, simplifying the support experience for subscribers and customer support representatives alike.

### SUMMARY OF THE INVENTION

Our Mobile Care Framework leverages the power of next generation devices and wireless packet data networks to provide automated technical support for next generation smartphones and wireless PDAs. Our framework extends the traditional customer support processes by automating the collection of accurate diagnostic information and automating the resolution of problems.

Our invention allows fast, accurate problem diagnostics that will help increase first call resolutions, reduce overall resolution times, and reduce the number of call escalations.

Our software collects detailed diagnostic information such as device resident applications, detailed device usage information, memory allocation, connection data, privacy and security settings, application version, firmware and operating system information and uses that information with the data store to drive complex service processes. Subscribers as well as customer service experts are guided step-by-step as they diagnose and solve problems, apply solutions, and upgrade to new versions of their applications. Subscribers enjoy a superior product experience, while MSPs (Mobile Service Providers) reduce customer service costs and gain a unique competitive advantage.

Our software suite has been designed to solve mobile data problems with a minimum of input from either the subscriber or the customer service agent. Automating the identification of the problem provides maximum efficiency for timely, targeted solutions to subscriber inquiries.

According to a first aspect of the invention, a method of providing customer care within a mobile care framework is provided, comprising:

capturing device profile data over-the-air from a device agent within a mobile device;

correlating the device profile data to a database of known mobile device issues and associated solutions to the mobile device issues; and

selectively forwarding to the mobile device over-the-air at least one of the solutions for execution by the device agent.

As used herein, the term “issues” includes broadly any type of device setting, configuration, or application that could be optimized, and is not limited to problems (or “bugs”) in resident software, and outdated software. As used herein, the term “solutions” means, with reference to “issues”, any optimization that can be implemented with respect to the device settings, configuration, or applications. The device agent may be proprietary technology or a third party application.

“Mobile device” is intended to be understood broadly to refer to any kind of device capable of using data transmission means for communication. Although here a smartphone or PDA is described as a preferred embodiment, the term “mobile device” may also include a mobile terminal, a camera, a toy, a gaming station, a vending machine, a vehicle, an appliance (such as a microwave oven or a coffee maker), or any of a variety of other types of devices.

Preferably, the capturing step comprises reading configuration data consisting of any or all of configuration settings, resident applications, and diagnostic data. The diagnostic data may include make and model of the device, total and available memory, total and available storage, battery life, connection strength, connection settings, user requests, usage statistics, soft reset count, recently used applications, memory heap.

Preferably, the device profile data is transmitted over-the-air using GPRS, CDMA, UMTS, iDEN, SMS, WiFi, Bluetooth, or infrared, or a combination of any of these. Alternatively, it will be understood that a cradle connection may be used to transmit device profile data without departing from the spirit of the invention.

Preferably, the correlating step comprises automatically selecting one or more solutions from among available application or firmware updates, configuration settings, problem resolutions, and user interface configurations.

The correlating step may also comprise escalating the problem to a second level customer service support bureau.

The method may be performed at the request of a user of the mobile device, or as a scheduled event automatically by the device agent, or at the request of a customer care center. If there are a plurality of mobile devices, the customer care center may perform the method for more than one mobile device substantially at the same time.

According to a second aspect of the invention a mobile care framework is provided comprising:

a customer care application;

a data store accessible by the customer care application;

an analytics engine for communication between the customer care application and the data store; and

at least one device agent capable of responding to commands from the customer care application, the device agent being located within a mobile device remote from the customer care application in over-the-air communication with the customer care application.

The customer care application is programmed to use the over-the-air connection to capture device profile data from the at least one device agent for correlation by the analytics engine with a database of known issues and associated solutions in the data store to selectively forward to the at least one mobile device agent at least one solution.

Preferably, the device profile data is selected from the group consisting of configuration settings, resident applications, and diagnostic data. Preferably, the diagnostic data consists of any or all of make and model of the device, total and available memory, total and available storage, battery life, connection strength, connection settings, user requests, usage statistics, soft reset count, recently used applications, memory heap.

Preferably, the device profile data is transmitted over-the-air using GPRS, CDMA, UMTS, iDEN, SMS, WiFi, Bluetooth, infrared, or a combination of any of these. Alternatively, it will be understood that a cradle connection may be used to transmit device profile data without departing from the spirit of the invention.

Preferably, the analytics engine is programmed to select at least one solution from among available application or firmware updates, configuration settings, problem resolutions, and user interface configurations.

Preferably, the device agent comprises an embedded application.

Preferably, the data store is linked to vendor and development community support. The data store may comprise one or a plurality of individual databases.

Preferably, the customer care application comprises a customer service representative interface.

Preferably, the analytics engine comprises a rule-based application.

According to a third aspect of the invention, a device agent is provided embedded in a mobile device capable of communicating over-the-air with a customer care application within a mobile care framework to provide device profile data relevant to the mobile device, and programmed to receive and execute at least one solution selectively forwarded over-the-air by the customer care application.

The device agent may comprise a user prompt to provide device profile data to the customer care application and receive and execute solutions.

The device agent may comprise a scheduler for timing scheduled provision of device profile data to the customer care application and receiving and executing solutions.

### BRIEF DESCRIPTION OF THE FIGURES

In order that the invention may be more clearly understood, the preferred embodiment thereof will now be described by way of example with reference to the accompanying drawings, in which:

FIG. 1 is an overview architecture diagram of the entire Mobile Care Framework;

FIG. 2 is an example of the data stored in the Mobile Care Data Stores;

FIG. 3 is an example of the process flow through our Analytics Engine; and

FIG. 4 is an example of the process flow for problem escalation.

### DETAILED DESCRIPTION OF THE PREFERRED EMBODIMENT

Our Mobile Care Framework 1 can be divided into six primary components: embedded diagnostic components, customer service center applications, data stores, analytics engine, development communication and hardware vendor support, and escalation.

Embedded Diagnostic Components

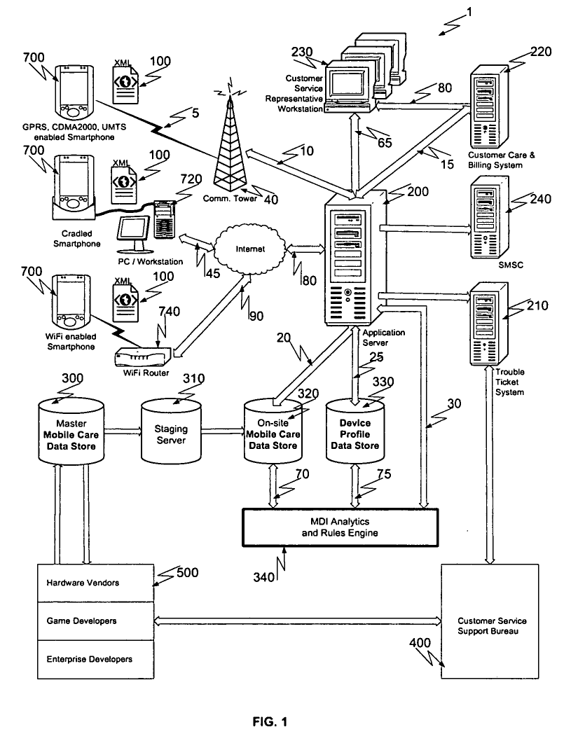

It is a fundamental principle of the present invention that service is embedded directly into the mobile device. An embedded component, known as a device agent 700, is preferably provided in each mobile device served in the present invention. As shown in FIG. 1, the device agent 700 may be resident in any of a number of types of mobile devices. Preferably, the device is a mobile device (such as a smartphone) enabled to communicate using an over-the-air data exchange protocol 5, such as GPRS, CDMA2000, or UMTS. (Such protocols use a communication tower 40 to relay data within a network.) However, the present invention also applies to devices enabled to communicate using a cradle or wired connection with a PC/Workstation 720, or as a “WiFi” device in communication with a WiFi router 740, either of which in turn, is enabled for communication over the Internet 45, 90. Preferably, the device agent 700 is programmed to be able to send and receive data in XML format 100, as shown in FIG. 1. According to the present invention, the device agent 700 automatically gathers information about the subscriber's device, such as resident applications, current configuration settings and diagnostic data. (As used herein, “subscriber” and “user” refer to the individual owner or user of the mobile device.) The device resident application also allows a self-care approach whereby the user can run on-device network connectivity checks; check a database for known application or driver updates, search a database of known information on device specific problems and the appropriate resolution. The device agent 700 can be dynamically configured to perform customer satisfaction surveys or display promotions based on logic rules supported by the analytics engine 340.

Our device agent 700 is a software application that resides and runs directly on the mobile device (shown in the Figures as a smartphone). The device agent 700 sends data from the device, and receives incoming data from our application server 200. Our device agent 700 allows communication with the application server 200 via the Internet 45, 80, 90 and OTA (Over-the-Air) 5, 10 using technologies such as GPRS, CDMA2000, UMTS, SMS, WiFi, Bluetooth, infrared. The communication (as shown at 720) may also involve a physical cradle connection. In cases where an Internet connection is not available, the device agent 700 can also receive commands and connection settings and send connection specific information to the server using SMS (Short Message Service) via a Short Message Service Center 240 in communication with the application server 200.

Our device agent 700 gathers diagnostic data from the device. Gathered data includes information such as the make and model of the device, total and available memory, total and available storage, installed applications, battery life, connection/signal strength, connection settings, user requests, usage statistics, soft reset count. The fields collected by the device agent are divided into 2 distinct sections:

1. User-specific (unique)

2. Device-specific (non-unique)

Preferably, any fields concerning the user-specific data requires privacy consent before collection has taken place. The device profile data is encapsulated into XML 100 which is then provisioned to our application server 200.

Secure communication may be established by using HTTPS/SSL encryption or public key/private key exchange.

The device agent 700 also features an XML 100-driven dynamic GUI (Graphic User Interface) to allow user interaction with the system. The user-interface is preferably dynamically configurable and allows the Mobile Care Framework 1 to deliver a personalized interface (not shown) to each individual device and mobile subscriber without changes to the device agent 700. For example, a mobile subscriber who selects “French” as their primary language will receive the “French” version of the XML 100 during the initial configuration of the device. A dynamically driven GUI reduces the amount of code that must be customized per mobile service provider.

The device agent 700 preferably allows for carriers to send promotional and user-specific surveys. Preferably, the device agent 700 listens for commands via SMS and GPRS (W-HTTP) and sends data through GPRS (W-HTTP). In cases where GPRS connection is not available, the device agent 700 can fall back and use SMS to transport the results of the promotions or the survey.

Preferably, the device agent 700 also features a scheduler, which allows commands to be automatically executed at predetermined times. These commands can include battery life monitoring, snapshot of recently used applications, snapshot of the memory heap, signal strength, and other device information which may assist in resolving a customer support issue. Otherwise, the device agent may be engaged by action of the subscriber/user (such as for self-help), or by action of the customer service center.

Responsive to the device profile data collected, the application server 200 preferably returns to the device agent 700 solution data preferably in XML 100 format. Our device agent receives data from the application server 200 such as available application or firmware updates, connection settings, problem resolutions, user interface configuration.

Example Device Connection Configuration XML Snippet:

<?xml version=″1.0″?>

| | |
|---|---|
| <rdf:RDF | xmlns:rdf=″http://www.w3.org/1999/02/22-rdf-syntax-ns#″ |

xmlns:mdi=″http://www.mobilediagnostix.com/v1/deviceprofile-20030301#″>

<rdf:Description rdf:ID=″SmartphoneDeviceProfile″>

<mdi:element>

<rdf:Description rdf:ID=″ConnectionSettings″>
<rdf:type

rdf:resource=″http://www.mobilediagnostix.com/v1/deviceprofile-
20030301#ConnectionSettings′/>

<mdi:ConnName>Fido-Internet</mdi:ConnName>
<mdi:ConnAPN>internet.fido.ca</mdi:ConnAPN>
<mdi:ConnUser>fido</mdi:ConnUser>
<mdi:ConnPass>fido</mdi:ConnPass>
<mdi:ConnDomain/>
<mdi:ConnDefault>true</mdi:ConnDefault>

</rdf:Description>

</mdi:element>
<mdi:element>

<rdf:Description rdf:ID=″Command″>

<mdi:Command>0</mdi:Command>
<mdi:ReportSet>

<rdf:Bag>

<rdf:Ii>SignalStrength</rdf:Ii>
<rdf:Ii>SMSConnectivity></rdf:Ii>
<rdf:Ii>InternetConnectivity</rdf:Ii>
<rdf:Ii>BatteryLife</rdf: Ii>

</rdf:Bag>

</mdi:ReportSet>

</rdf:Description>

</mdi:element>

...............
...............
...............
</rdf:RDF>

Customer Service Center Applications

Our framework 1 includes web-based customer support representative facing screens on a customer service center application 230 that help customer service center staff quickly diagnose and solve problems for mobile device subscribers. Customer support representatives (not shown) can preferably view and take action on the diagnostic profile data collected from the user's mobile device using the embedded device agent 700, reducing the time spent collecting basic information from the subscriber and thereby reducing average call handling time (ACHT). Based on the information collected from the mobile device agent 700, our customer service center application 230 will guide the customer service representative (not shown) to the appropriate solution. Subscribers will appreciate the added convenience, service and product functionality delivered by the technology. More importantly, subscribers value mobile devices that remain ‘in tune’ with the latest features and fixes.

Our customer care center application 230 is in communication with the application server 200, the analytics engine 340, Master Data Store 300, On-Site Mobile Care Data Store 320, and the device profile data store 330. Preferably, the Master Data Store 300 containing known updates and problem resolution updates the On-site Mobile Care Data Store 320 using a Staging Server 310 at the carrier's site. The Staging Server 310 is not a requirement to our customer care center application 230, however it is recommended to allow carriers to test and validate newly added data.

The application server 200 interfaces with the carrier's customer care and billing system 220 to identify and retrieve information about the customer account and subscription plan. Each interface is specific to each carrier and will need to be custom developed according to the each carrier's infrastructure and particular requirements. Once the subscriber has been identified, the application server 200 passes relevant fields to the analytics engine 340.

The analytics engine 340 utilizes rule-sets to match the criteria of known fixes or resolutions and returns the identifier(s) to the matching resolution(s) contained in the on-site Mobile Care Data Store 320. The application server generates the XML 100 to be passed back to the device agent 700. Using the XML 100, the device agent 700 dynamically renders the user-interface on the device with available updates and resolutions. The user is able to choose the level of interaction with the device agent 700 from fully-automated through fully-manual. Once the customer selects the desired updates or resolutions, and request for update is made, the application server 200 sends the requested updates or resolutions to the device.

This combination of data gathered from the device by the device agent 700 and processed by the analytics engine 340 is then displayed to the CSR preferably via HTML based screens on the CSR workstation 230.

The user-interface of the customer service center application 230 is preferably a web-based system, driven by the application server 200 and analytics engine 340 to display the mobile subscriber's device profile information from the device profile data store 330, updates and relevant support history. Using gathered data from the device, the customer service representative can view near real-time data and the history specific to the subscriber.

Preferably, the customer service representative's screens use JSPs (Java Server Pages) for layout and branding customizations. The session management and transactional logic are handled via the application server 200 using Enterprise Java Beans technologies (Session Beans, Entity Beans). By using this method, future branding and/or text changes can be made without customizations to the application logic.

The JSPs dynamically generate the screens based on the access-level of the individual Customer Service Support Representative.

Preferably, a management console (not shown) is also provided at the customer service center. The management console is preferably a web-based system, driven by the application server 200 to administer the system. Alternatively, the management console may comprise an interface using screens other than HTML screens, such as screens built using PowerBuilder, a SWING, or some other custom interface. The management console provides these functionalities:

CSR user Management (add, delete, modify)

Access-Level Management

Auditing/Logging Management

Using the management console (not shown), a system administrator can create and assign roles and groups for different departments and individual CSR's. Preferably, there are three types of access-level control:

1. CSR user-based (specific control for the CSR)

2. Role-based (administrator, CSR, etc. . . . )

3. Group-based (dept1, dept2, dept3, etc. . . . )

CSR user-based access control overrides settings for role-based access control, and role-based access control overrides settings for group-based access control. By combination of the three types of access-level control, the system can accommodate a large scope of mobile carrier's security policies and requirements.

The management console may also be used to view and configure the system access logs and system trace logs. These logs track each event and actions recorded by the system. Configuration of the amount of detail and granularity of the event triggering mechanism controls the data recorded in such log files.

Data Stores

Within the Mobile Care Framework 1, several data stores are preferably provided: the Master Data Store 300, Mobile Care Data Store 320, and Device Profile Data Store 330.

The main data store, Master Data Store 300 is preferably a database populated with known mobile data problems and their corresponding resolutions. The Master Data Store 300 will allow for rapid access to known bugs and application conflicts. Reuse of problem resolution will increase efficiency of problem resolution exponentially. Preferably, the Master Data Store 300 is linked to application and device issue and resolution data provided by the application development community 500, including hardware vendors, game developers, and enterprise developers. Application developers 500 will have a channel to upload application updates and patches through the Master Data Store 300. Once an update or patch is loaded to the Master Data Store 300, the update will be available to all customer service application systems 230 with an interface to the Master Data Store 300. The system will allow multiple simultaneous mobile service providers and application vendor connections. In turn, the Master Data Store 300 will be able to provide real world detailed feedback to the application development community 500, allowing them to keep accurate and fully documented reports of bugs, requests and resolutions. The Master Data Store 300 acts as a central repository, while the On-Site Data Store 320 (typically located in the carrier or mobile service provider's premises) may contain only a sub-set of the data in the Master Data Store 300. The data in the On-Site Data Store 320 may be periodically refreshed from data in the Master Data Store 300.

The Master Mobile Care Data Store 300 and the Device Profile Data Store 330 are used throughout the Mobile Care Framework 1 to provide data to the various Mobile Care Framework 1 components. The Master Mobile Care Data Store 300 contains known update paths, application conflicts and resolutions, and problematic symptoms and fixes. The use of a staging server 310 to push the updated solution set to the carrier's on-site Data Store 320 is optional. The staging server 310 allows for validation of a newly acquired solution and/or to allow for carrier security policies to be enforced without customizations to the Mobile Care Framework 1. The Device Profile Data Store 330 contains all customer specific profile information (such as number of soft resets, recently used applications, installed application list) where the information is unique to a specific customer and device-specific profile information (such as processor-type, flash ROM size, firmware version, screen resolution) where the information is unique to a specific device type.

Each Master Mobile Care Data Store 300 may be hosted by any Java Database Connectivity (JDBC)-compliant database system. Connectivity to the Data Stores is preferably achieved via JDBC 20, 25, 70, 75. Connection from the application server 200 is handled by a connection pool where a set number of connections are established by the application server 200 and distributed to threads requiring a database connection. Connection from the analytics engine 340 is handled by a dedicated connection for each analytics engine 340 process.

The development community and hardware vendors 500 will preferably use a web-based interface (not shown) to insert, modify, update new patches or resolutions to the Master Mobile Care Data Store 300.

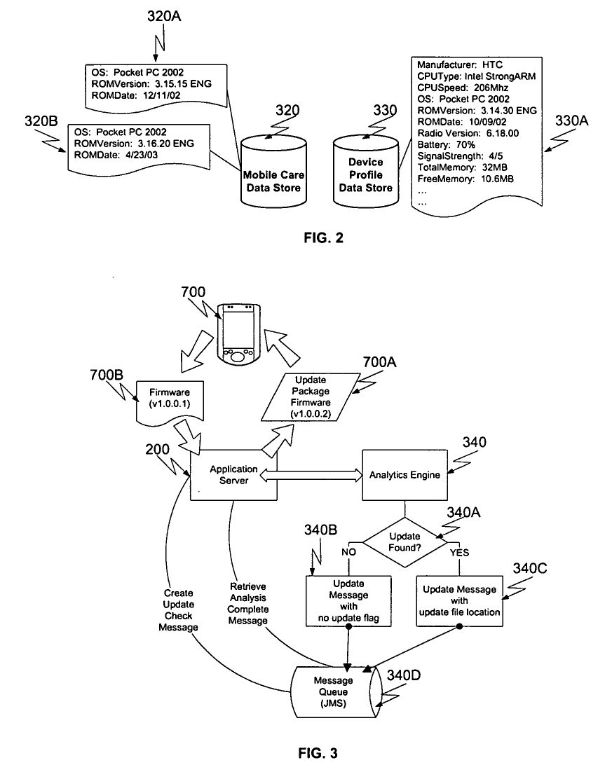

Some examples of the data stored in the On-Site 320 and Device Profile Data Stores 330 are shown in FIG. 2. For instance, in the On-Site Mobile Care Data Store 320, we have the actual patches and software updates for bug fixes (as shown for example in the data snippets at 320A, 320B), whereas in the Device Profile Data Store 330 we have the device profile data (as shown for example in the data snippet at 330A).

Analytics Engine

Our analytics engine 340 is the heart of our Mobile Care Framework 1. Business intelligence and processing rule-based scenario/symptom matching are handled by the analytics engine 340. Using a flexible rules based approach, the analytics engine 340 can process data and correlate device profile characteristics with known problems. The analytics engine 340 runs on its own process using Java Messaging Service (JMS) or Java RMI (Remove Method Invocation) to connect 30 to the main application server 200. This allows the analytics engine 340 to be upgraded, load-balanced, and failed-over transparently and separately from the application server 200. The analytics engine 340 preferably uses its own rule-compiler to allow for complex rules and filters.

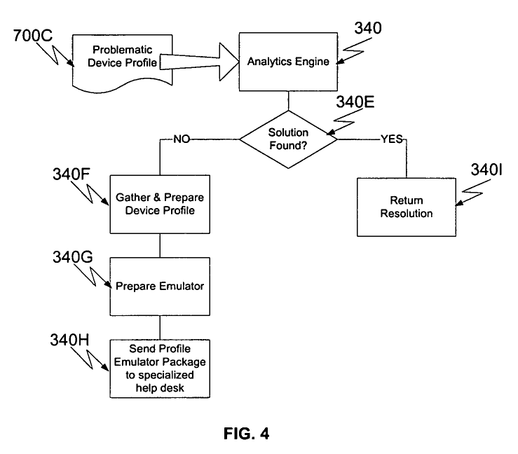

As shown in FIG. 3, our Analytics Engine 340 determines the path and actions based on device and customer profile and the appropriate rule-set. The application server 200 preferably prepares a decision query message using a customer identifier from the Customer Care & Billing System 220 and provisions it into the analytics engine 340. The analytics engine 340 determines if there is an update 340A or solution corresponding to the customer's profile history and device profile, and if so, what is the optimal update or solution, and then sends a decision response message back to the application server 200 messaging queue asynchronously using JMS (Java Message Service). For example, when a device agent 700 sends a profile with a firmware version 1.0.0.1 700B to the application server 200, it will create a message in the Message Queue 340D. Once the analytics engine 340 processes the profile step 340A, it will update the message 340C stored in the queue with the found solution (firmware version 1.0.0.2 in this example) 700A. The application server 200 will pickup the completed message and provision the solution to the device agent 700 for installation. Otherwise, if no update is found the analytics engine 340 will respond with a flag that no update was found 340B.

The analytics engine 340 will be used to determine which handsets or profiles are good candidates for receiving promotions and new application notifications. The system will also push results to the network group when signal strength in a particular Cell-ID is consistently below a certain level, so that the coverage holes could be plugged.

Connectivity to the application server 200 is preferably handled via Java RMI (Remote Method Invocation) which uses standard TCP/IP transport.

Development Community & Hardware Vendor Support

User-installed applications, peripherals, and device firmware/ROMs require periodic updates or fixes to maintain optimal performance and stability in next-generation phones and mobile devices. The Mobile Care Framework 1 allows for application developers and hardware vendors 500 to upload an update, patch or fix to a centralized location (the Master Data Store 300) and allow the analytics engine 340 to patch based on device type, OS build, or any data element collected by the embedded diagnostic device agent 700. Such an update or “patch” is actually a package of items, including a software patch as well as information concerning the relevant time to apply the patch, information about the symptom, the characteristics to be matched, and other factors. The Mobile Care Framework 1 also preferably includes a reporting tool (not shown) specific to the development community and vendor community 500 support. To share information gathered by the Mobile Care Framework 1 with the community 500 while preserving subscriber privacy, this reporting tool (not shown) preferably allows searches based on any non-personally identifiable fields gathered by the embedded diagnostic device agent 700. This interface (not shown) preferably allows external developers 500 to access reports on their application stability.

Hardware vendors and the development community 500 are preferably given access to the Mobile Care Data Store 300 to provide updates, patches or resolutions matching problem/symptom criteria. For example, a smartphone camera vendor may find a bug in their camera driver that surfaces when device=X and operating system version=Y. Once the fix has been created, the file and criteria for applying the fix can be inserted into the Mobile Care Data Store 300, so that device profiles returning X, Y together can receive the bug fix.

The interface also preferably provides the developers and vendors 500 access to non-personally identifiable statistics from the Device Profile Data Store 330 such as number of device X with operating system Y. This feature allows the developers and vendors 500 to allocate resources according to install-base. Preferably, this interface is also based on the same technologies as the Customer Service Center Applications 230 (above). Connectivity to the interface will preferably use HTTPS/SSL transport to provide secure communication since the data will be transferred using the Internet.

The development community and hardware vendors 500 will preferably have access to query the Mobile Care Data Store 300 and non-unique Device Profile Data Store 330. Although some pre-built queries will preferably be shown, each user will have access to a dynamic SQL query build tool, which allows for custom queries using the available data fields.

Data uploaded to the Mobile Care Data Store 300 and 320 become available to the Mobile Care Framework 1 after a rule set has been created for it. A rule-set may contain multiple files along with multiple rule-set dependencies. For example, a new patch can be uploaded to fix a problem for a Nokia™ 7610 smartphone. Until a rule-set is created in 340 which says “to fix Nokia™ 7610 problem send file to device” this file cannot be accessed.

Escalation

As shown in FIG. 4, in situations where a solution is not automatically found 340E for a problematic device profile 700C, the Mobile Care Framework 1 preferably allows for an individual device profile provided by the embedded device agent 700 to be packaged 340F and provisioned 340H to either a specialized help desk or 3^{rd} party support bureau 400 to further investigate the problem. This device profile package 340F contains all known historical data (install history, uninstall history, registry data, recently used application list, memory statistics, firmware, OS build, etc) about the device as well as a pre-configured emulator profile 340G matching the customer's device.

Escalation of a new problem is preferably handled in two steps. These steps provide the shortest path to identify and resolve new problems and efficient use of the data stored in the Mobile Care Framework 1. The first is an automated trouble-ticket creation and emulator packaging system 210. Once the problematic cause is identified, but can not be solved by the 2^{nd} level customer service support bureau 400, the second step of escalation can occur. This involves removal of unique identifiers in the device profile package 340F and information exchange about the investigation of the problem from the 2^{nd} level customer service support bureau 400.

The automated escalation handling system of Mobile Care Framework 1 is a tool the 2^{nd} level customer service support bureau 400 would use to first identify and locate the cause of the problem. For example, when a problem with a smartphone 700 application is found to have no known fix, the application server 200 creates a trouble-ticket and an emulator package (not shown). The 2^{nd} level customer service representative opens the trouble-ticket 210, which will include a detailed description about the problem and a pre-configured emulator profile matching the device profile of the mobile subscriber's device.

If the problem can not be resolved without assistance from the vendor 500, to preserve user privacy, the emulator package is preferably modified to remove all unique identifiers such as phone numbers, contacts, personal documents, etc. The profile can be packaged in an emulator or a report document to be sent to a particular vendor for further investigation.

The foregoing is considered as illustrative only of the principles of the invention. Further, since numerous modifications and changes will readily occur to those skilled in the art, it is not desired to limit the invention to the exact processes, components and applications shown and described, and accordingly, all suitable modifications and equivalents may be resorted to, falling within the scope of the invention and the appended claims and their equivalents. For instance, the “mobile device” could in fact comprise a PDA or advanced PDA, a mobile terminal, a camera, a toy, a gaming station, a vending machine, a vehicle, an appliance (such as a microwave oven or a coffee maker), or practically any kind of device capable of using data transmission means for communication. Furthermore, the transmission means may exploit any and all radio frequencies, infrared, acoustic waves, telemetric techniques in general, including 4G, 3G (standards like wCDMA, UMTS, iDEN), 2.5G (standards like 1xRTT, GPRS, EDGE), among others.

What is claimed is:

1. A method of providing customer care within a mobile care framework, comprising:
capturing device profile data over-the-air from a device agent within a mobile device;
correlating the device profile data to a database of known mobile device issues and associated solutions to the mobile device issues; and
selectively forwarding to the mobile device over-the-air at least one of the solutions for execution by the device agent.

2. The method of claim 1, wherein the capturing step comprises reading configuration data pertaining to the mobile device.

3. The method of claim 1, wherein the capturing step comprises reading resident applications in the mobile device.

4. The method of claim 1, wherein the capturing step comprises reading device profile data selected from the group consisting of configuration settings, resident applications, and diagnostic data.

5. The method of claim 4, wherein the diagnostic data comprises diagnostic data selected from the group consisting of make and model of the device, total and available memory, total and available storage, battery life, connection strength, connection settings, user requests, usage statistics, soft reset count, recently used applications, memory heap.

6. The method of claim 1, wherein the device profile data is transmitted over-the-air using GPRS.

7. The method of claim 1, wherein the device profile data is transmitted over-the-air using at least one protocol selected from the group consisting of GPRS, CDMA, UMTS, iDEN, SMS, WiFi, Bluetooth, and infrared.

8. The method of claim 1, wherein the correlating step comprises automatically selecting one or more solutions from among available application or firmware updates, configuration settings, problem resolutions, and user interface configurations.

9. The method of claim 1, wherein the correlating step further comprises escalating the problem to a second level customer service support bureau.

10. The method of claim 1, wherein the method is performed at the request of a user of the mobile device.

11. The method of claim 1, wherein the method is performed as a scheduled event automatically by the device agent.

12. The method of claim 1, wherein the method is performed at the request of a customer care center.

13. The method of claim 12, wherein there are a plurality of mobile devices, and the customer care center performs the method for more than one mobile device substantially at the same time.

14. A mobile care framework comprising:
a customer care application;
a data store accessible by the customer care application;
an analytics engine for communication between the customer care application and the data store;
at least one device agent capable of responding to commands from the customer care application, the device agent being located within a mobile device remote from the customer care application in over-the-air communication with the customer care application;
wherein the customer care application is programmed to use the over-the-air connection to capture device profile data from the at least one device agent for correlation by the analytics engine with a database of known issues and associated solutions in the data store to selectively forward to the at least one mobile device agent at least one solution.

15. The mobile care framework of claim 14, wherein the device profile data is selected from the group consisting of configuration settings, resident applications, and diagnostic data.

16. The mobile care framework of claim 15, wherein the diagnostic data comprises diagnostic data selected from the group consisting of make and model of the device, total and available memory, total and available storage, battery life, connection strength, connection settings, user requests, usage statistics, soft reset count, recently used applications, memory heap.

17. The mobile care framework of claim 14, wherein the device profile data is transmitted over-the-air using GPRS.

18. The mobile care framework of claim 14, wherein the device profile data is transmitted over-the-air using a protocol selected from the group consisting of GPRS, CDMA, UMTS, iDEN, SMS, WiFi, Bluetooth, and infrared.

19. The mobile care framework of claim 14, wherein the analytics engine is programmed to select at least one solution from among available application or firmware updates, configuration settings, problem resolutions, user interface configurations.

20. The mobile care framework of claim 14, wherein the device agent comprises an embedded application.

21. The mobile care framework of claim 14, wherein the data store is linked to vendor and community support.

22. The mobile care framework of claim 14, wherein the customer care application comprises a customer service representative interface.

23. The mobile care framework of claim 14, wherein the analytics engine comprises a rule-based application.

24. A device agent embedded in a mobile device capable of communicating over-the-air with a customer care application within a mobile care framework to provide device profile data relevant to the mobile device, and programmed to receive and execute at least one solution selectively forwarded over-the-air by the customer care application.

25. The device agent of claim 24, wherein the device agent comprises a user prompt to provide device profile data to the customer care application and receive and execute solutions.

26. The device agent of claim 24, wherein the device agent comprises a scheduler for timing scheduled provision of device profile data to the customer care application and receiving and executing solutions.
